(19) United States
(12) Patent Application Publication
(10) Pub. No.: US 2018/0204170 A1
(43) Pub. Date: Jul. 19, 2018

(54) STORAGE LOCATION ASSIGNMENT DEVICE AND METHOD FOR A STORAGE SYSTEM

(71) Applicant: Jusda International Logistics (TAIWAN) CO.,LTD, Taoyuan (TW)

(72) Inventors: CHIA-LIN KAO, New Taipei (TW); FENG-TIEN YU, Taipei City (TW)

(21) Appl. No.: 15/408,606

(22) Filed: Jan. 18, 2017

(51) Int. Cl. G06Q 10/08; G06F 7/02; G06Q 30/02

(52) U.S. Cl. CPC G06Q 10/087; G06Q 30/0635; G06Q 30/0283; G06F 7/026

(57) ABSTRACT

A storage location assignment device to efficiently store and pick goods from a warehouse includes a processor and an input unit. The input unit can accept inputs of goods orders. Warehouse information known to a memory of the processor includes the aisles, rows, locations, and layers of the warehouse. The memory includes instructions for the processor, to generate updated locations assignments. A display device is also coupled to the processor and configured to output visual representations of the updated locations assignments.

### FIELD

The subject matter herein generally relates to a storage location assignment device and method for a storage system.

### BACKGROUND

The locations of products in a warehouse need to be decided. Types of storage assignment, such as random storage, closest open location storage, dedicated storage, full turnover storage, and class-based storage are used for different situations. Today's manufacturers or E-commerce concerns face more competition and time pressure, especially on picking efficiency in the warehouse in order to satisfy supply chain or customer service. Therefore, storage location assignment in a warehouse is important from both process improvement and logistical aspects. The present disclosure provides a device and a storage location assignment device and method for a storage system.

### BRIEF DESCRIPTION OF THE DRAWINGS

Implementations of the present technology will now be described, by way of example only, with reference to the attached figures.

FIG. 1 illustrates a system diagram of a storage system in accordance with aspects of the disclosure.

FIG. 2 illustrates a block diagram of a storage location assignment device in accordance with an implementation.

FIG. 3 illustrates a diagram of coordinates of items for storage location in a warehouse in accordance with an implementation.

FIG. 4 illustrates a system diagram illustrating calculation of the distance between items in different row areas, in accordance with an implementation.

FIG. 5 illustrates a system diagram illustrating calculation of the distance between items in the same row areas, in accordance with an implementation.

FIG. 6 illustrates another calculation of the distance between items in the same row areas, in accordance with an implementation.

FIG. 7 illustrates an example flowchart for routing strategies in a storage system in accordance with an implementation.

FIG. 8 illustrates a diagram illustrating routing in a storage system, in accordance with an implementation of the flowchart of FIG. 7.

FIG. 9 illustrates an example flowchart of a method for a storage location assignment device in accordance with an implementation

FIG. 10 illustrates an exchange of items for a storage location assignment device in accordance with an implementation

FIG. 11 illustrates another example flowchart for a storage location assignment device in accordance with an implementation

FIG. 12 is an application interface of a storage location assignment device.

FIG. 13 is another application interface of a storage location assignment device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

The term “comprising” means “including, but not necessarily limited to”; it specifically indicates open-ended inclusion or membership in a so-described combination, group, series and the like.

The present disclosure provides a storage system to manage products and their storage locations in a warehouse via a storage location assignment device and method.

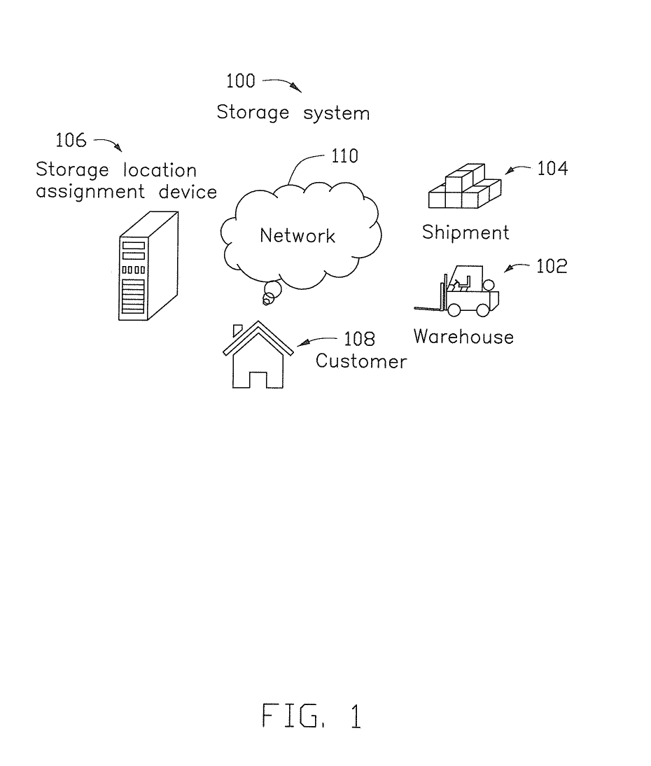

FIG. 1 illustrates a storage system 100. The storage system 100 comprises a warehouse 102, shipment 104 (e.g., items of goods sold and awaiting shipping to customer), a storage location assignment device 106, at least one customer 108, and a network 110. In the instant embodiment, the warehouse 102, the storage location assignment device 106, and the customer 108 are communicatively coupled through the network 110, wherein the network is provided by a server in a cloud center. Customer, warehouse, and shipment information can be stored as data and processed in the server. The customer 108 provides a purchase order via the network 110 (the network may be through internet, or telephone or fax, etc.), wherein the purchase order comprises at least one item. The storage location assignment device 106 is configured to receive purchase orders from different customers 108 and provide storage location information to the warehouse 102. The information based on the orders from the customer 108 may be computed by the storage location assignment device 106. The shipment 104 in the warehouse or to be stored in the warehouse can be put into a storage location based on information provided by the storage location assignment device 106. The information comprises storage location assignment information.

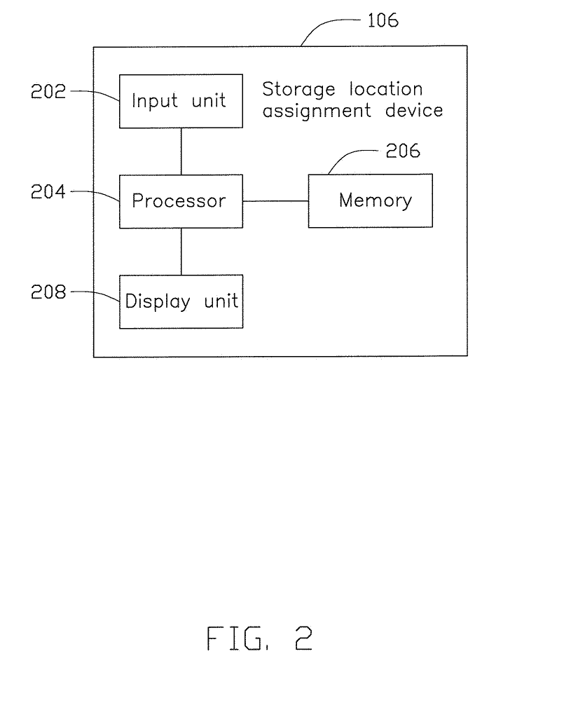

FIG. 2 illustrates the components for an exemplary storage location assignment device 106. The exemplary storage location assignment device 106 comprises an input unit 202, a memory 206, a processor 204, and a display unit 208. The input unit 202 is directly and indirectly coupled to the processor 204, and the device 106 is operable to allow input of orders (e.g., total number of orders) and warehouse information (e.g., storage location coordinates). The memory 206 receives and stores orders and warehouse information. The processor 204 executes programs and applications to achieve storage location assignments. The results of operations by the device 106 may comprise (1) frequency of items (e.g., turnover of goods), (2) correlation between two items (e.g., The correlation between items is defined by the frequency of two items appearing in customers' orders at the same time., whether the frequency of the items is in the same order, whether the items of different brands but having the same/similar function, whether the items in the orders from the same or different customers), (3) coordinates for storage, (4) physical distance between two items and (5) exchange value from exchanging the locations of two items as hereinafter defined. In an embodiment, the exchange value from exchanging the location of the two items is defined as calculating an improvement or reduction in picking cost (the difference in picking cost) before and after the exchange of at least two items. For example, the picking cost is exchange value based on travel distances which are calculated before and after the exchange of at least two items.

In some exemplary embodiment, the storage location assignment device 106 may be implemented in a tabular form listing each of the electronic devices in the communication network and the associated identification number. The memory 206 may be implemented by a static random access memory (SRAM), a dynamic random access memory (e.g., DRAM, SDRAM, DDR, DDRII), a Flash memory (e.g., NAND Flash, NOR Flash), or Read only memory (e.g., ROM, EPROM, EEPROM).

In some exemplary embodiment, the input unit 202 and the display unit 208 may be remote and wirelessly connected, in an electronic device (e.g., cellular telephone, personal digital assistant (PDA), laptop, radio, broadcasting, walkie-talkie, etc.).

In some exemplary embodiment, the memory 206 and the processor 204 may be in a cloud computing center.

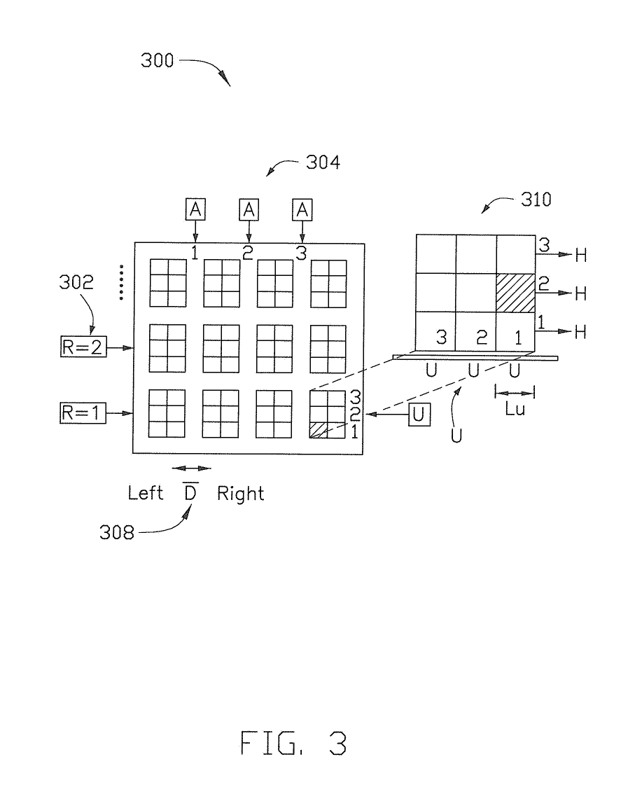

FIG. 3 illustrates a presentation (labelled 300) of coordinates of items for storage location in a warehouse. The coordinates of the items for storage location can be defined by five parameters. Parameter “R” defines row 302 in the warehouse. Parameter “A” defines aisle 304 in the warehouse. Parameter “U” defines position 306 in the layer of the rack. Parameter “D” defines side 308 of the aisle 304, wherein D=1 means left side of the aisle, and D=2 means right side of the aisle. Parameter “H” defines layer 310 of the rack. For example, if an item is stored in location 350 the coordinates of the item are R=1, A=3, U=1, D=2 and H=2.

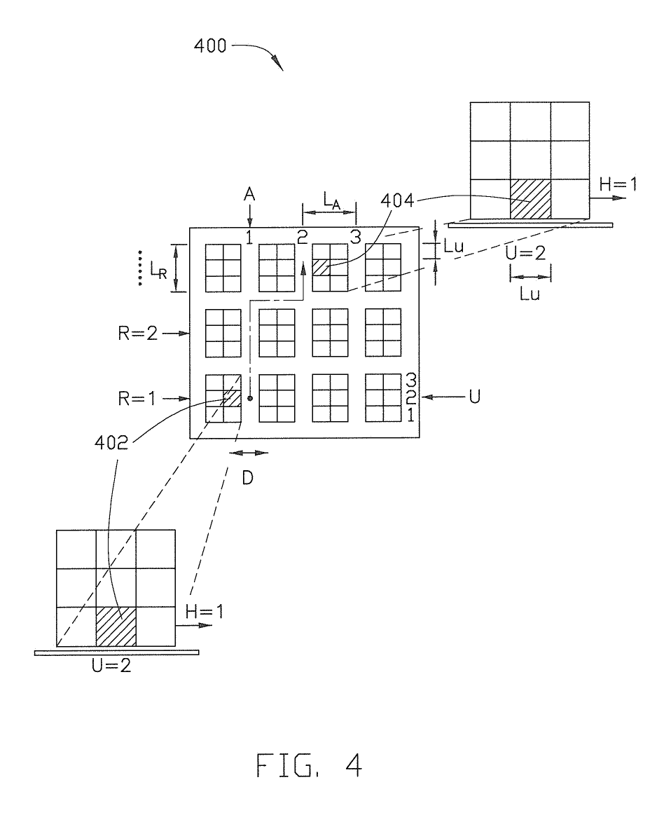

FIG. 4 illustrates a presentation (400) showing the calculation of the physical distance between items. In this embodiment, the first item is stored in the first location 402, wherein the first location is defined as (Rᵢ, Aᵢ, Uᵢ, Dᵢ, Hᵢ). The second item is stored in the second location 404, wherein the second location 404 is defines as (Rⱼ, Aⱼ, Uⱼ, Dⱼ, Hⱼ). When the distance tᵢⱼ between two items in different row areas (Rᵢ≠Rⱼ), the distance tᵢⱼ can be calculated as tᵢⱼ=L_{A}|Aᵢ−Aⱼ|+(L_{R}|Rᵢ−Rⱼ|+L_{U}|Uᵢ−Uⱼ|). For instance, when the first location 402 is at (1, 1, 2, 1, 1), the second location 404 is at (3, 2, 2, 2, 1), and the distance tᵢⱼ can be calculated as tᵢⱼ=L_{A}|Aᵢ−Aⱼ|+(L_{R}|Rᵢ−Rⱼ|+L_{U}|Uᵢ−Uⱼ|)=L_{A}|1−2|+(L_{R}|1−3|+L_{U}|2−2|)=L_{A}+2L_{R}.

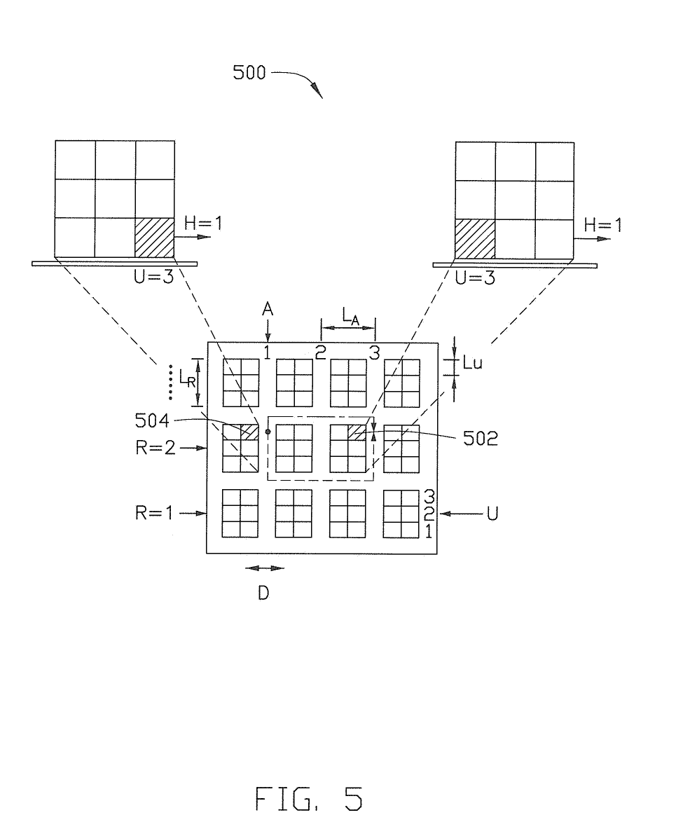

FIG. 5 illustrates another presentation (500) of a calculation of the distance between items. In one embodiment, the first item is stored in the first location 502, wherein the first location 502 is defined as (Rᵢ, Aᵢ, Uᵢ, Dᵢ, Hᵢ). The second item is stored in the second location 504, wherein the second location 504 is defined as (Rⱼ, Aⱼ, Uⱼ, Dⱼ, Hⱼ). When the distance tᵢⱼ between two items in the same row area (Rᵢ₌Rⱼ), the distance tᵢⱼ can be calculated as Aᵢ≠Aⱼ.

When Aᵢ≠Aⱼ, the distance tᵢⱼ can be calculated as tᵢⱼ=L_{A}|Aᵢ−Aⱼ|+min{L_{U}(Uᵢ+Uⱼ), 2 L_{R}−L_{U}(Uᵢ+Uⱼ)}. For instance, when the first location 502 is at (2, 3, 3, 1, 1),and the second location 504 is at (2, 1, 3, 1, 1), the distance tᵢⱼ can be calculated as tᵢⱼ=L_{A}|Aᵢ−Aⱼ|+min{L_{U}(Uᵢ+Uⱼ), 2 L_{R}−L_{U}(Uᵢ+Uⱼ)}=L_{A}|3−1+min{L_{U}(3+3), and 2 L_{R}−L_{U}(3+3)}=2L_{A}+min{6L_{U}, 2 L_{R}−6L_{U}}=2L_{A}+min{6L_{U}, 6 L_{U}−6L_{U}}=2 L_{A}+min{69L_{U}, 0}=2L_{A}.

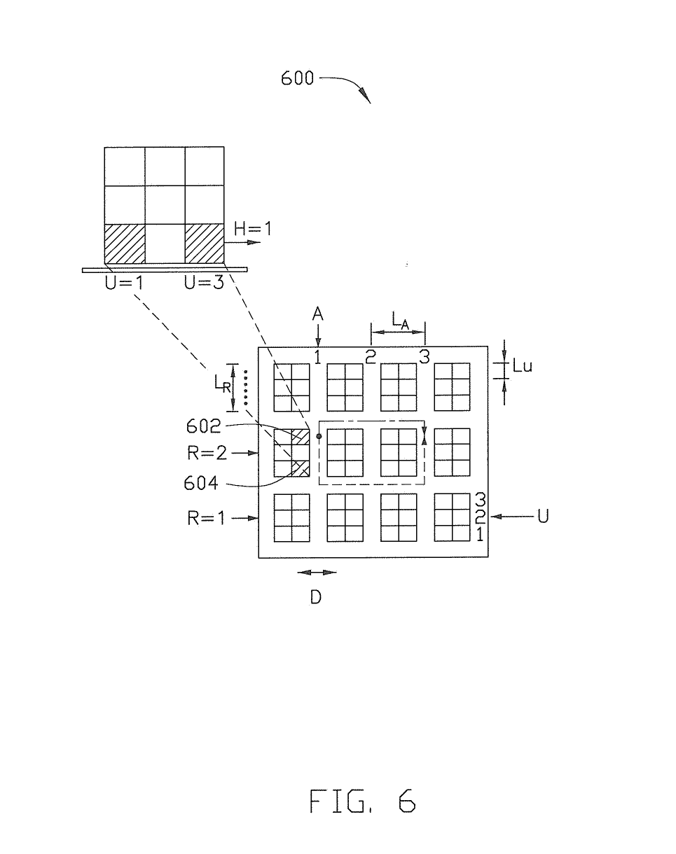

FIG. 6 illustrates another presentation (600) of a calculation of the distance between items. In one embodiment, the first item is stored in the first location 602, wherein the first location 602 is defined as (Rᵢ, Aᵢ, Uᵢ, Dᵢ, Hᵢ). The second item is stored in the second location 604, wherein the second location 604 is defined as (Rⱼ, Aⱼ, Uⱼ, Dⱼ, Hⱼ). When the distance tᵢⱼ between two items in the same row area (Rᵢ₌Rⱼ), the distance tᵢⱼ can be calculated as Aᵢ=Aⱼ.

When Aᵢ₌Aⱼ, the distance tᵢⱼ can be calculated as tᵢⱼ=L_{U}|Uᵢ−Uⱼ| while Uᵢ≠Uⱼ.For instance, when the first location 602 is at (2, 1, 3, 1, 1), the second location 604 is at (2, 1, 1, 1, 1), and the distance tᵢⱼ can be calculated as tᵢⱼ=L_{U}|Uᵢ−Uⱼ|=L_{U}|1−3|=2L_{U}.

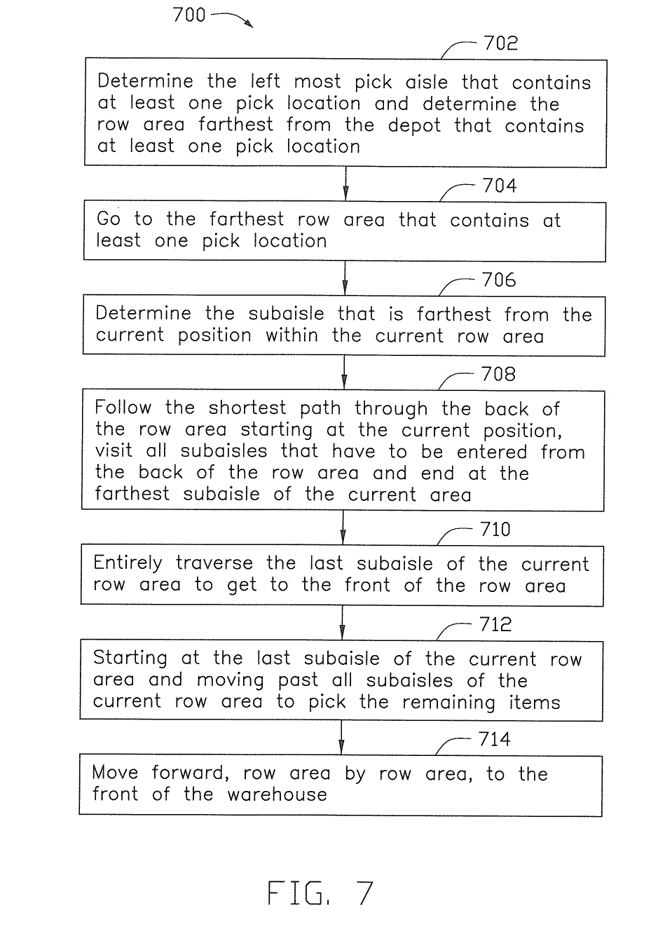

FIG. 7 illustrates an exemplary flowchart of a process 700 on routing strategies for a layout with multiple cross aisles for picking items in a storage system or warehouse, according to at least one example. In some example, the one or more storage location assignment devices 106 (e.g., the mobile device, the laptop, the personal computer, and/or the tablet shown) in FIG. 2 may perform the process 700 of FIG. 7. The process 700 may begin at block 702 by determining the leftmost pick aisle that contains at least one pick location, and also determining the row area farthest from the depot that contains at least one pick location.

At block 704, the process 700 may include establishing the farthest row area that contains at least one pick location. In some example, the process 700 may begin at block 702 by determining the rightmost pick aisle that contains at least one pick location, and also determining the row area farthest from the depot that contains at least one pick location.

At block 706, the process 700 may include determining the subaisle that is farthest from the current location within the current row area.

At block 708, the process 700 may include determining the shortest path through the back of the row area starting at the current location, and visiting all subaisles that have to be entered from the back of the row area and end at the farthest subaisle of the current area.

At block 710, the process 700 may include entirely traversing the last subaisle of the current row area to get to the front of the row area.

At block 712, the process 700 may include starting at the last subaisle of the current row area and moving past all subaisles of the current row area to pick the remaining items.

At block 714, the process 700 may include moving forward, row area by row area, to the front of the warehouse.

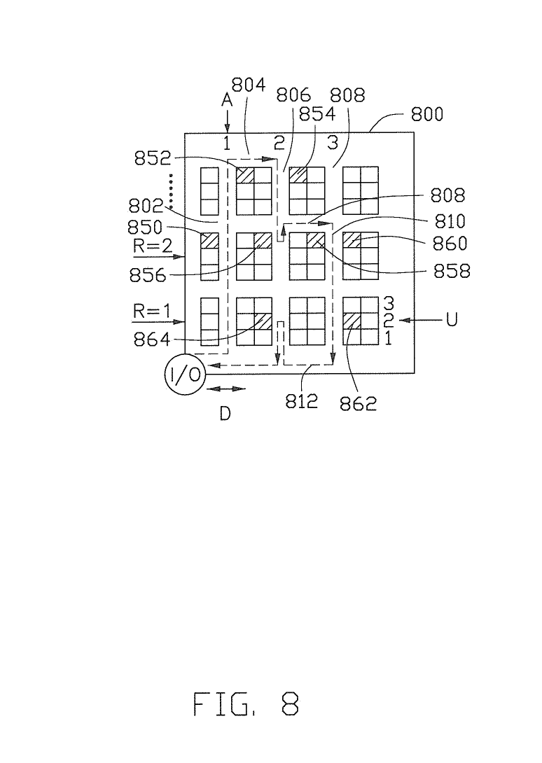

FIG. 8 illustrates an example routing strategy in a warehouse 800 according to the process 700 in FIG. 7. The routing starts by moving along the aisle 802 which has two pick locations 850 and location 852. The routing process continues by changing direction after passing the location 852 and moving along the row 804, the direction is changed after arriving the location 854 at the aisle 804. The routing process continues and turns around when arriving at the location 856 at aisle 806. Then the routing process continues by moving along the row 808, and the direction is changed after passing the location 858 and arriving the location 860 at the aisle 810 crossing the row 808. The routing process continues by moving along the aisle 810 and passing the location 862 and turning to the row 812 after the wall of the warehouse is visible. The routing process continues, and the direction is changed to the aisle 806 so that the routing process can include picking items at the location 864. After arriving the location 864, the routing process continues by turning around and moving back to the row 812. Finally, the routing process is finished when moving back to the starting point.

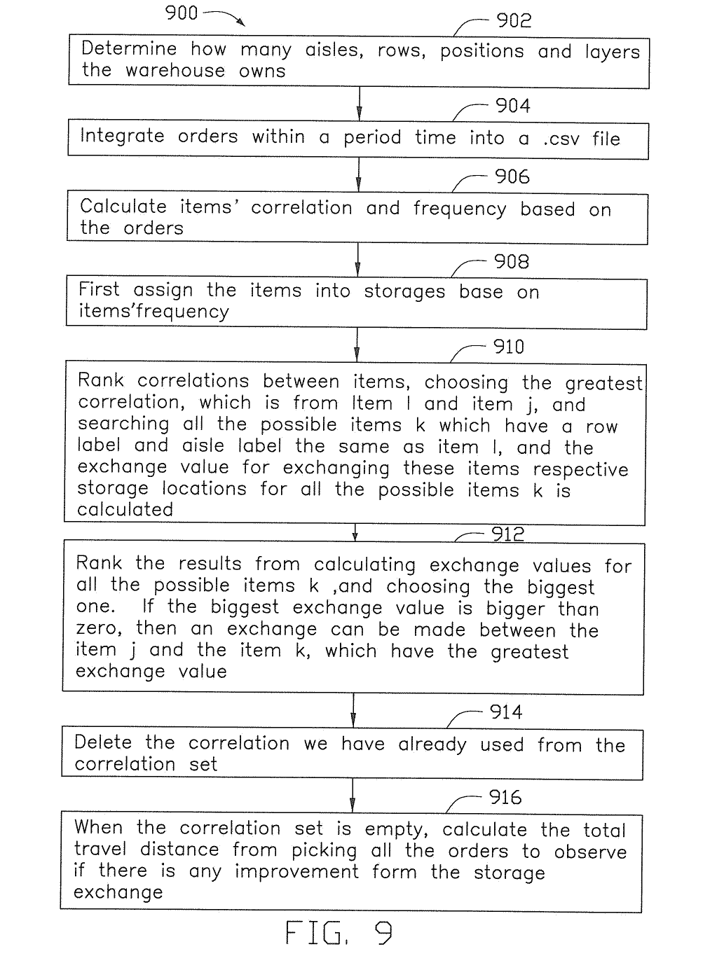

FIG. 9 illustrates an example flowchart for a method of storage location assignment. The exchange value from exchanging the locations of two items according to at least one example is determined. In some example, the one or more storage location assignment devices 106 (e.g., the mobile device, the laptop, the personal computer, and/or the tablet) shown in FIG. 2 may perform the process 900 of FIG. 9.

In some embodiment, a storage location assignment device, as in FIG. 2, for assigning stock items into storage locations in the warehouse may comprise a processor and an input unit communicatively coupled to the processor and configured to accept input of orders and warehouse information. The warehouse information may comprise at least one of aisle, row, location, and layer information. The order information may comprise at least one item for purchase. A memory (which may include a volatile and/or non-volatile memory) is coupled to the processor and configured to receive the orders and the warehouse information. The memory may comprises instructions stored therein which, upon execution by the processor, causes the processor to perform operations. The operations may include an exemplary process 900 of FIG. 9, wherein the process 900 can be implemented by the storage system 100 in FIG. 1 and the storage location assignment device 106 described in FIG. 2.

The process 900 may begin at block 902 by determining how many aisles, rows, positions, and layers exist in the warehouse.

At block 904, the orders are created and integrated within a period of time into a document file (e.g., MS EXCEL, .csv file, MS WORD file) by the processor.

At block 906, the correlation of items and frequency information can be calculated based on the orders.

At block 908, the items can be assigned into storage locations based on items' frequency.

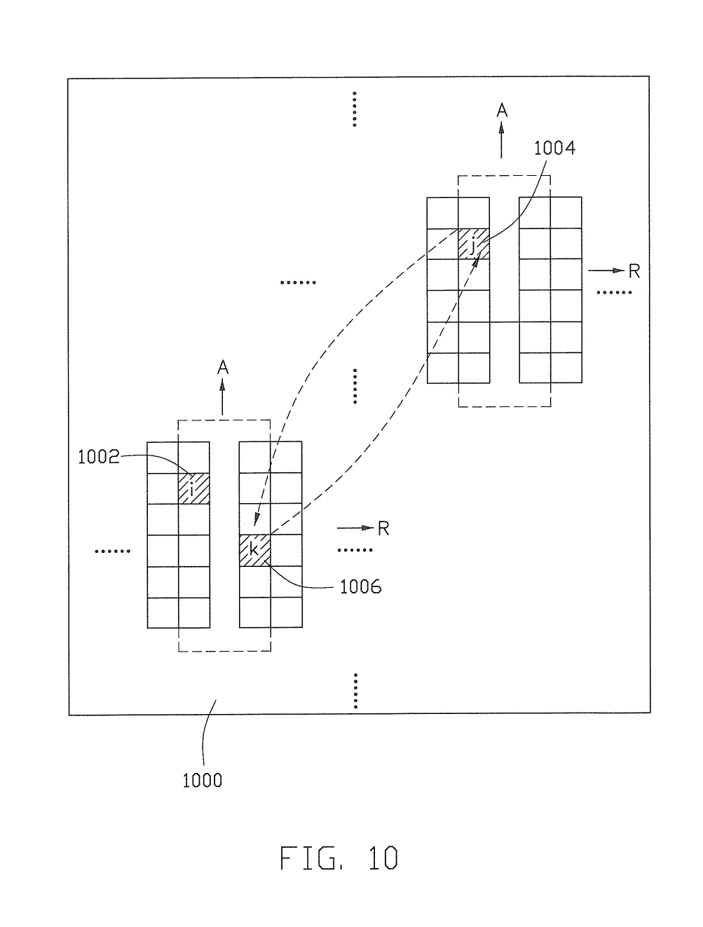

At block 910, the process 900 can include ranking of correlations between items, choosing the greatest correlation which is from a first Item and a second item, and searching all the possible third items which has a row label and aisle label location the same as the first item, and calculating the exchange value s from current locations for all the possible third items. In at least one embodiment, the presentation in FIG. 10 illustrates the working of the process 900 of FIG. 9. The exemplary process can include a ranking of correlations between items (as presented in FIG. 10 and labelled 1000), choosing the greatest correlation, which is from Item l 1002 and item j 1004, and searching all the possible items k 1006 which have a row label and aisle label the same as item l 1002. The exchange value for exchanging these items respective storage locations for all the possible items k 1006 is calculated.

At block 912, the process 900 can include ranking the results from calculating exchange value s for all the possible third items, and choosing the greatest one. If there is an exchange value greater than zero between the second item and the third item then choosing that exchange value is the greatest one. In at least one embodiment, the process 900 can refer to and produce the presentation of FIG. 10. The process 900 can include ranking the results from calculating exchange value s for all the possible items k 1006, and choosing the greatest one. If the exchange value is bigger than zero, then an exchange can be made between the item j 1004 and the item k 1006, which have the greatest exchange value.

At block 914, the process 900 can include deleting a correlation already used from the correlation set.

At block 916, when the correlation set is empty, the total travel distances from picking all the orders is calculated, to determine any improvement as a result of storage exchange.

In some embodiments, the correlation between items is based on the Apriori method. Apriori is an algorithm for frequency sets mining and association rule learning over transactional databases. It proceeds by identifying the frequent individual items in the database and extending them to larger and larger item sets as long as those item sets appear sufficiently often in the database. The frequent item sets determined by Apriori can be used to determine association rules which highlight general trends in the database: this has applications in domains such as market basket analysis.

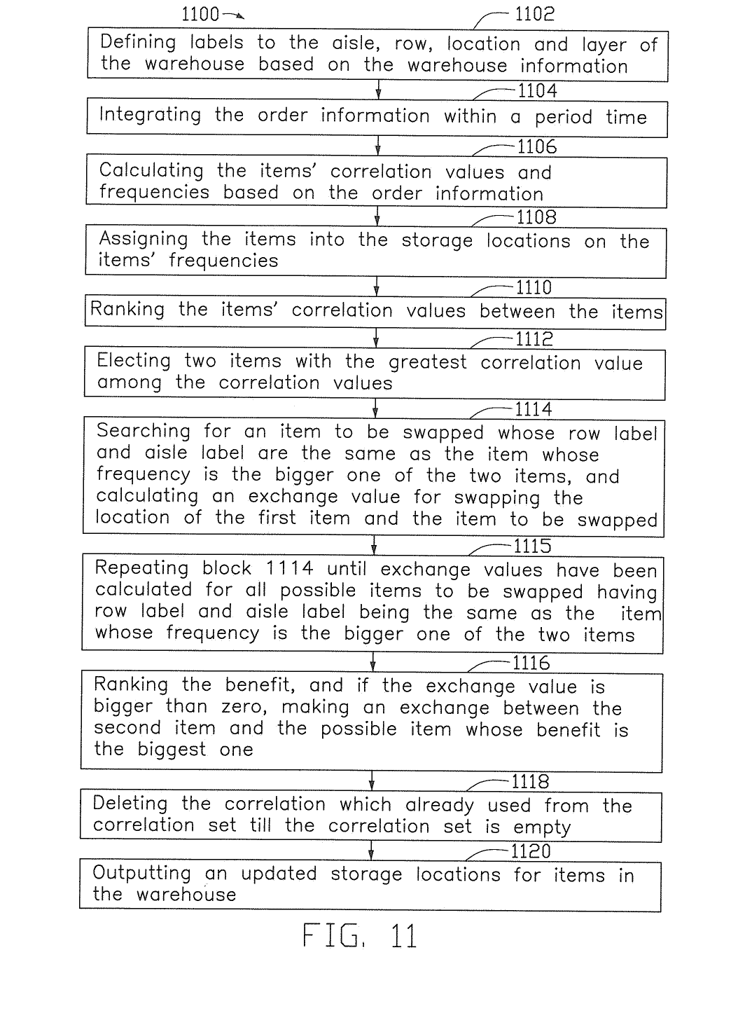

In some embodiments, a device according to the storage location assignment device as in FIG. 2 for assigning a plurality of items into storage locations in the warehouse which may comprise a processor and an input interface communicatively coupled to the processor and configured to accept input of order information and warehouse information. The warehouse information may comprise at least one of aisle, row, location, and layer information. The order information may comprise an order for at least one of items stored in the warehouse. A computer readable medium is coupled to the processor and configured to receive the orders and the warehouse information. The computer readable medium may comprise instructions stored therein which, upon execution by the processor, causes the processor to perform operations. The operations may include an exemplary process 1100 of FIG. 11, wherein the process 1100 can be implemented by the storage system 100 and the storage location assignment device 106.

The process 1100 may begin at block 1102 by defining labels to the aisle, row, location and layer of the warehouse based on the warehouse information

At block 1104, the process 1100 may include integrating the order information within a period time, wherein the period time may be an hour, a week, a month, a year.

At block 1106, the process 1100 may include calculating the items' correlation values and frequencies based on the order information.

At block 1108, the process 1100 may include assigning the items into the storage locations on the items' frequencies.

At block 1110, the process 1100 may include ranking the items' correlation value between the items.

At block 1112, the process 1100 may include selecting two items with the greatest correlation value among the correlation values.

At block 1114, the process 1100 may include searching for an item to be swapped whose row label and aisle label are the same as the item whose frequency is the bigger one of the two items, and calculating an exchange value for swapping the location of the first item and the item to be swapped.

At block 1115, the process 1100 may include repeating block 1114 until exchange values have been calculated for all possible items to be swapped having row label and aisle label being the same as the item whose frequency is the bigger one of the two items.

At block 1116, the process 1100 may include ranking the exchange value, and if the exchange value is greater than zero, making an exchange between the second item and the third item has the largest exchange value calculated.

At block 1118, the process 1100 may include deleting the correlation which already used from the correlation set till the correlation set is empty.

At block 1120, the process 1100 may include outputting an updated storage locations for items in the warehouse.

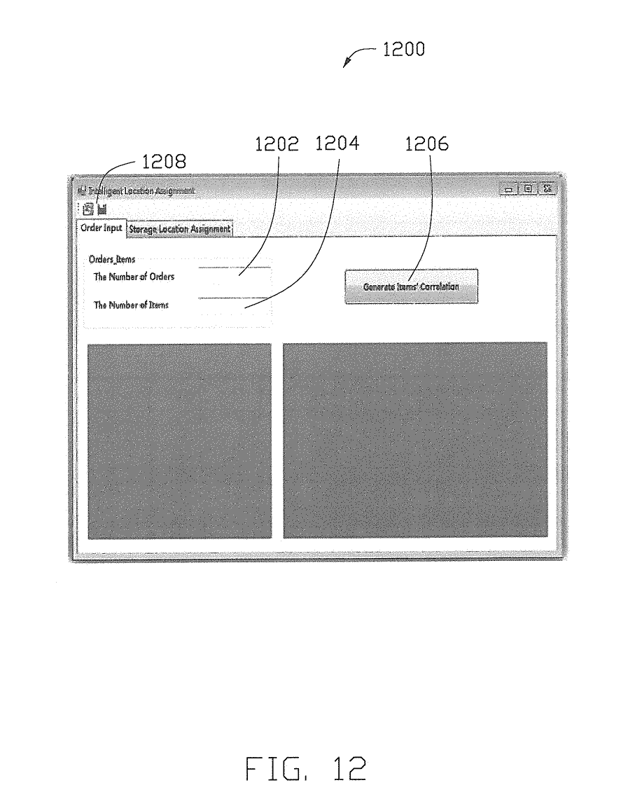

FIG. 12 illustrates an embodiment of an application interface 1106 for a storage location assignment device is provided. Users can use the application interface 1106 to input orders and items information. For example, the orders are input by a excel .csv file 1208, and the number of orders 1202 and the number of items 1204 can be shown in the application interface 1106. The items' correlation value and frequency can be generated based on the orders information and items information when the users press a button 1206.

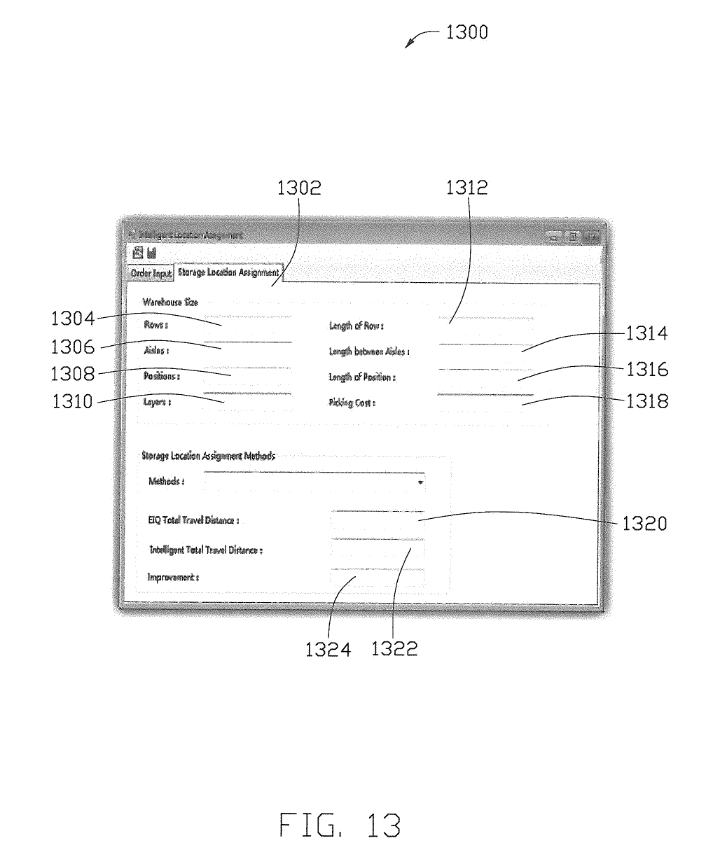

FIG. 13 illustrates another embodiment of an application interface 1300 for a storage location assignment device. The users can use the application interface 1300 to input the warehouse information by choosing a block “storage location assignment” 1302. The warehouse information comprises the warehouse size information including the number of aisles “Aisle” 1306, the number of rows “Rows” 1304, the number of positions “Positions” 1308 and the number of layers “layers” 1310 information. The warehouse size information further comprises the length information including “Length of Row” 1312, “Length between Aisles” 1314, “Length of Position” 1316. The application interface 1300 is also configured to show the picking cost 1318, wherein the picking cost can be calculated through exchanging at least two items. The exchange value from exchanging the location of the two items may define as improvement by calculating picking cost before and after the exchange of at least two items. The exchange value from exchanging the location of the two items may define as improvement by calculating travel distance before and after the exchange of at least two items.

In some embodiments, the application interface 1300 shows the “EIQ total travel distance” 1320 which may be calculated by EIQ analysis. The EIQ analysis may include EQ analysis, IQ analysis, EN analysis, and IK analysis. EQ means the items' volume for each order. IQ means the total volume of each item. EN means the number of types of items in each order. IK means the frequency that each item is selected. The application interface 1300 shows the “intelligent total travel distance” 1322 which may be calculated by the analysis according to the flow charts in accordance with FIG. 7, FIG. 9 and FIG. 11. The exchange value may refer to the improvement between the EIQ total travel distance and the intelligent total travel distance.

The embodiments shown and described above are only examples. Many details are often found in the art such as the other features of a vehicle scheduling device and method for transportation system. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A storage location assignment device for assigning a plurality of items into storage locations in a warehouse comprising:
a processor;
an input unit communicatively coupled to the processor and configured to accept input of order information and warehouse information, wherein the warehouse information comprises at least one of aisle, row, position and layer information, wherein the order information comprises an order for at least one of items stored in the warehouse;
a computer readable medium coupled to the processor and configured to receive the order and the warehouse information, the computer readable medium further comprising instructions stored therein which, upon execution by the processor, causes the processor to perform operations comprising:
a) defining labels to the at least one of aisle, row, location and layer of the warehouse based on the warehouse information;
b) integrating the order information within a period of time;
c) calculating the items' correlation values and frequencies based on the order information;
d) assigning the items into the storage locations based on the items' frequencies;
e) ranking the items' correlation values between the items;
f) selecting two items with the greatest correlation value among the correlation values, ranking the selected items so that the first item's frequency is bigger than that of the second one;
g) searching for an item to be swapped whose row label and aisle label are the same as the first item, and calculating an exchange value for swapping the location of the first item and the item to be swapped;
h) repeating step g) until exchange values have been calculated for all possible items to be swapped having row label and aisle label being the same as the first item whose frequency is the bigger one of the two items;
i) ranking the exchange value, and if the exchange value is greater than zero, making an exchange between the second item and the third item has the largest exchange value calculated.

2. The storage location assignment device of claim 1, wherein the order information further comprises turnover rate of at least one item.

3. The storage location assignment device of claim 1, wherein the operations further comprises deleting the correlation which already used from the correlation set till the correlation set is empty.

4. The storage location assignment device of claim 1, wherein the storage location assignment device further comprises a display unit coupled to the processor and configured to output an updated storage locations for items in the warehouse.

5. The storage location assignment device of claim 1, wherein the exchange value defines as improvement by calculating picking cost before and after the exchange of at least two items.

6. The storage location assignment device of claim 1, wherein the exchange value defines as improvement by calculating travel distance before and after the exchange of at least two items.

7. The storage location assignment device of claim 1, wherein the processor is further configured to, upon execution of the instructions, calculate frequency of items.

8. The storage location assignment device of claim 1, wherein the processor is further configured to, upon execution of the instructions, calculate correlation between two items.

9. The storage location assignment device of claim 1, wherein the processor is further configured to, upon execution of the instructions, calculate coordinates for storage.

10. The storage location assignment device of claim 1, wherein the processor is further configured to, upon execution of the instructions, calculate distance between two items.

11. The storage location assignment device of claim 1, wherein the correlation value between items is calculated based on the Apriori Method

12. The storage location assignment device of claim 1, wherein the exchange value from ranking define as improvement by calculating picking cost.

13. The storage location assignment device of claim 12, wherein the picking cost is based on travel distances which are calculated before and after the exchange of at least two items.

14. A storage system comprising:
an input unit configured to accept input of order and warehouse information, wherein the warehouse information comprises at least one of aisle, row, position and layer information, wherein the order information comprises an order for at least one of items stored in the warehouse;
a storage location assignment device comprising:
a processor coupled to the input unit and configured to perform operations;
a computer readable medium coupled to the processor and configured to receive the order and the warehouse information, the computer readable medium further comprising instructions stored therein which, upon execution by the processor, causes the processor to perform the operations comprising:
a) defining labels to at least one of the aisle, row, location and layer of the warehouse based on the warehouse information;
b) integrating the order information within a period of time;
c) calculating the items' correlation values and frequencies based on the order information;
d) assigning the items into the storage locations based on the items' frequencies;
e) ranking the items' correlation value between the items;
f) selecting two items with the greatest correlation value among the correlation values, ranking the selected items so that the first item's frequency is bigger than that of the second one;
g) searching for an item to be swapped whose row label and aisle label are the same as the first item, and calculating an exchange value for swapping the location of the first item and the item to be swapped;
h) repeating step g) until exchange values have been calculated for all possible items to be swapped having row label and aisle label being the same as the first item whose frequency is the bigger one of the two items;
i) ranking the exchange value, and if the exchange value is greater than zero, making an exchange between the second item and the third item has the largest exchange value calculated;
j) deleting the correlation which already used from the correlation set till the correlation set is empty.
a display unit coupled to the processor and configured to output a updated storage locations for the items in a warehouse.

15. The storage system of claim 14, wherein the processor is further configured to, upon execution of the instructions stored in the computer readable medium, assign the items to the storage location based on the updated storage locations.

16. The storage system of claim 14, wherein the input unit can be an electronic device communicatively coupled to a network.

17. The storage system of claim 11, wherein the storage location assignment device is in a cloud computing center communicatively coupled to a network.

18. A storage location assigning method performed by the storage system, comprising the steps of:
a) importing order and the warehouse information through an input unit;
b) defining labels to the aisle, row, location and layer of the warehouse based on the warehouse information;
c) integrating the order information within a period of time;
d) calculating the items' correlation values and frequencies based on the order information;
e) assigning the items into the storage locations based on the items' frequencies;
f) ranking the items' correlation value between the items;
g) selecting two items with the greatest correlation value among the correlation values, ranking the selected items so that the first item's frequency is bigger than that of the second one;
h) searching for an item to be swapped whose row label and aisle label are the same as the first item, and calculating an exchange value for swapping the location of the first item and the item to be swapped;
i) repeating step g) until exchange values have been calculated for all possible items to be swapped having row label and aisle label being the same as the first item whose frequency is the bigger one of the two items;
j) ranking the exchange value, and if the exchange value is greater than zero, making an exchange between the second item and the third item has the largest exchange value calculated;
k) deleting the correlation which already used from the correlation set till the correlation set is empty.

19. The storage location assigning method of claim 18, further comprising the steps of: displaying an updated storage locations assignment on the display screen by a display unit.

20. The storage location assigning method of claim 18, wherein the correlation value between items is calculated based on the Apriori Method.
